(19) United States
(12) Patent Application Publication
(10) Pub. No.: US 2022/0027923 A1
(43) Pub. Date: Jan. 27, 2022

(54) ELECTRONIC RECEIPT SYSTEM, PROCESSING APPARATUS, AND PROCESSING METHOD

(71) Applicant: NEC Corporation, Minato-ku, Tokyo (JP)

(72) Inventor: Yuki TSURUOKA, Tokyo (JP)

(73) Assignee: NEC Corporation, Minato-ku, Tokyo (JP)

(21) Appl. No.: 17/299,899

(22) PCT Filed: Nov. 15, 2019
(86) PCT No.: PCT/JP2019/044834

§ 371 Date: Jun. 4, 2021

(51) Int. Cl. G06Q 30/00; G06Q 30/06

(52) U.S. Cl. CPC G06Q 30/016; G06Q 30/0631; G06Q 30/0627

(57) ABSTRACT

The present invention provides an electronic receipt system (100) including a storage unit (21) that stores electronic receipt information for each user, a change information acquisition unit (11) that acquires change information related to a change in raw material for a product, a target user determination unit (12) that determines, based on the electronic receipt information, a user who has purchased, in the past, a change product being a product having a raw material changed or a related product being related to the change product, and a notification unit (13) that notifies the determined user of the change information.

### TECHNICAL FIELD

The present invention relates to an electronic receipt system, a processing apparatus, and a processing method.

### BACKGROUND ART

PTLs 1 to 3 disclose a technique for determining, based on information in which a prohibition material such as an allergic substance is registered for each customer and a product registered to be settled at a time of settlement, whether a product including the prohibition material is included in the product to be settled.

### CITATION LIST

### Patent Literature

[PTL 1] Japanese Patent Application Publication No. 2017-68792

[PTL 2] Japanese Patent Application Publication No. 2008-15785

[PTL 3] Japanese Patent Application Publication No. 2007-4672

### SUMMARY OF INVENTION

### Technical Problem

A raw material for a product may be changed due to a renewal of the product. Then, due to the renewal, a prohibition material may be added to the raw material for the product, and a prohibition material may be removed from the raw material for the product. Note that, the prohibition material is a material that cannot be taken in due to a health reason, a religious reason, and the like, and what kind of material is a prohibition material is different for each customer.

Due to the renewal as described above, a product that has been purchased may not become able to be purchased, and a product that cannot be purchased may become able to be purchased. There has been no means for notifying an appropriate user of such a situation. PTLs 1 to 3 do not disclose a means for solving the problem described above.

A problem to be solved by the present invention is to notify an appropriate user of a change in raw material for a product.

### Solution to Problem

The present invention provides an electronic receipt system including,

a storage unit storing electronic receipt information for each user,

a change information acquisition unit acquiring change information related to a change in raw material for a product,

a target user determination unit determining, based on the electronic receipt information, a user who has purchased, in the past, a change product being a product having a raw material changed or a related product being related to the change product, and

a notification unit notifying a determined user of the change information.

Further, the present invention provides a processing method executed by a computer, the method including,

storing electronic receipt information for each user,

a change information acquisition step of acquiring change information related to a change in raw material for a product,

a target user determination step of determining, based on the electronic receipt information, a user who has purchased, in the past, a change product being a product having a raw material changed or a related product being related to the change product, and

a notification step of notifying a determined user of the change information.

Further, the present invention provides a processing apparatus including,

an acquisition unit acquiring electronic receipt information,

a change information acquisition unit acquiring change information related to a change in raw material for a product,

a target user determination unit determining, based on the electronic receipt information, a user who has purchased a change product being a product having a raw material changed or a related product being related to the change product, and

a notification unit notifying a determined user of the change information.

Further, the present invention provides a processing apparatus including,

a material specification unit specifying a material, and

a search unit searching for, from a purchased product indicated by electronic receipt information to be processed, the purchased product including a specified material and having a first time limit of the purchased product indicated by the electronic receipt information satisfying a predetermined condition.

### Advantageous Effects of Invention

The present invention is able to notify an appropriate user of a change in raw material for a product.

### BRIEF DESCRIPTION OF DRAWINGS

The above-described object, the other objects, features, and advantages will become more apparent from suitable example embodiments described below and the following accompanying drawings.

FIG. 1 is one example of a functional block diagram of an electronic receipt system according to a present example embodiment.

FIG. 2 is a diagram illustrating one example of a hardware configuration of a processing apparatus according to the present example embodiment.

FIG. 3 is a diagram schematically illustrating one example of an electronic receipt according to the present example embodiment.

FIG. 4 is a diagram schematically illustrating one example of electronic receipt information stored in a storage unit according to the present example embodiment.

FIG. 5 is a diagram schematically illustrating one example of change information according to the present example embodiment.

FIG. 6 is a diagram schematically illustrating one example of change information according to the present example embodiment.

FIG. 7 is a diagram schematically illustrating one example of related information according to the present example embodiment.

FIG. 8 is a flowchart illustrating one example of a flow of processing of the processing apparatus according to the present example embodiment.

FIG. 9 is a diagram schematically illustrating one example of prohibition information according to the present example embodiment.

FIG. 10 is a flowchart illustrating one example of a flow of processing of the processing apparatus according to the present example embodiment.

FIG. 11 is a flowchart illustrating one example of a flow of processing of the processing apparatus according to the present example embodiment.

FIG. 12 is a flowchart illustrating one example of a flow of processing of the processing apparatus according to the present example embodiment.

FIG. 13 is one example of a functional block diagram of the electronic receipt system according to the present example embodiment.

FIG. 14 is a diagram schematically illustrating one example of product information according to the present example embodiment.

FIG. 15 is a flowchart illustrating one example of a flow of processing of the processing apparatus according to the present example embodiment.

FIG. 16 is a diagram schematically illustrating one example of the electronic receipt according to the present example embodiment.

FIG. 17 is a diagram schematically illustrating one example of electronic receipt information stored in the storage unit according to the present example embodiment.

FIG. 18 is a flowchart illustrating one example of a flow of processing of the processing apparatus according to the present example embodiment.

FIG. 19 is diagram for explaining a processing content of the processing apparatus according to the present example embodiment.

FIG. 20 is one example of a functional block diagram of the electronic receipt system according to the present example embodiment.

FIG. 21 is a diagram schematically illustrating one example of contact address information according to the present example embodiment.

### EXAMPLE EMBODIMENT

### First Example Embodiment

First, an outline of an electronic receipt system according to a present example embodiment will be described. The electronic receipt system stores electronic receipt information for each user. The electronic receipt information is information indicating a content of an electronic receipt, specifically, a purchased product and the like.

Then, when the electronic receipt system acquires change information related to a change in raw material for a product, the electronic receipt system determines, based on the stored electronic receipt information, a user who has purchased, in the past, a change product being a product having a raw material changed or a related product being related to the change product. Then, the electronic receipt system notifies the determined user of the change information.

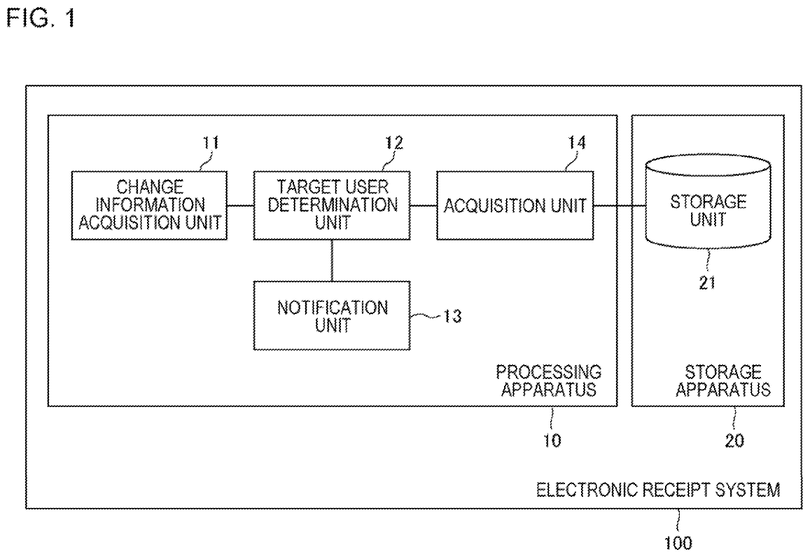

Next, a configuration of an electronic receipt system 100 will be described in detail. FIG. 1 is one example of a functional block diagram of the electronic receipt system 100. As illustrated, the electronic receipt system 100 includes a processing apparatus 10 and a storage apparatus 20. The processing apparatus 10 and the storage apparatus 20 are connected to each other in a wired and/or wireless manner, and are configured to be communicable to each other.

Herein, one example of a hardware configuration of the processing apparatus 10 will be described. Each functional unit included in the processing apparatus 10 is achieved by any combination of hardware and software concentrating on a central processing unit (CPU) of any computer, a memory, a program loaded into the memory, a storage unit such as a hard disk that stores the program (that can also store a program downloaded from a storage medium such as a compact disc (CD), a server on the Internet, and the like, in addition to a program previously stored at a stage of shipping of an apparatus), and a network connection interface. Then, various modification examples of an achievement method and an apparatus thereof are understood by a person skilled in the art.

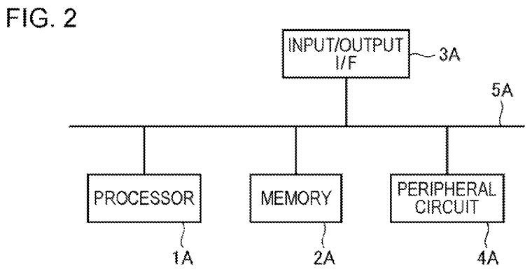

FIG. 2 is a block diagram illustrating a hardware configuration of the processing apparatus 10. As illustrated in FIG. 2, the processing apparatus 10 includes a processor 1A, a memory 2A, an input/output interface 3A, a peripheral circuit 4A, and a bus 5A. Various modules are included in the peripheral circuit 4A. The processing apparatus 10 may not include the peripheral circuit 4A. Note that, the processing apparatus 10 may be formed of a plurality of apparatuses being separated physically and/or logically. In this case, each of the plurality of apparatuses can include the hardware configuration described above.

The bus 5A is a data transmission path for the processor 1A, the memory 2A, the peripheral circuit 4A, and the input/output interface 3A to transmit and receive data to and from each other. The processor 1A is an arithmetic processing apparatus such as a CPU and a graphics processing unit (GPU), for example. The memory 2A is a memory such as a random access memory (RAM) and a read only memory (ROM), for example. The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, and the like. The output apparatus is, for example, a display, a speaker, a printer, a mailer, and the like. The processor 1A can output an instruction to each of modules, and perform an arithmetic operation, based on an arithmetic result of the modules.

Next, one example of a functional configuration of the electronic receipt system 100 will be described. As illustrated in FIG. 1, the processing apparatus 10 includes a change information acquisition unit 11, a target user determination unit 12, a notification unit 13, and an acquisition unit 14. Then, the storage apparatus 20 includes a storage unit 21.

The storage unit 21 stores electronic receipt information for each user. The electronic receipt information is information indicating a content of an electronic receipt, specifically, a purchased product and the like.

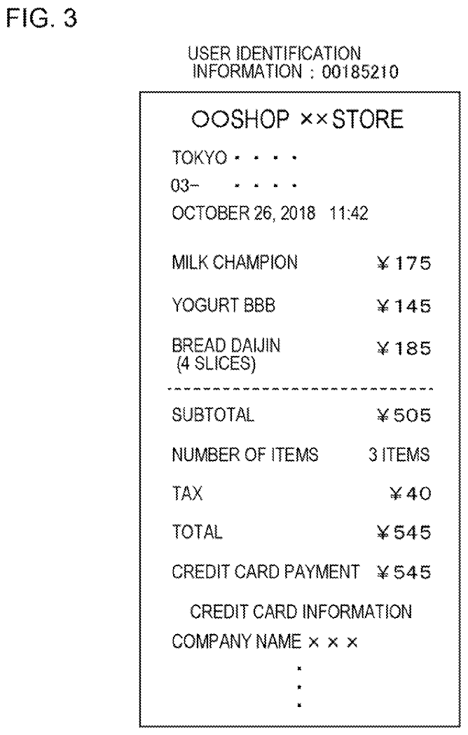

FIG. 3 illustrates one example of an electronic receipt. The illustrated electronic receipt is an electronic receipt issued in response to shopping at ∘∘ Shop x x Store. The illustrated electronic receipt includes store identification information that identifies a store where a purchase is made, a date on which the purchase is made, a shopping content (information indicating a purchased product), a payment method, and the like.

For example, a store system of a store that issues an electronic receipt generates the electronic receipt. Then, the store system transmits, to the electronic receipt system 100, the generated electronic receipt in association with user identification information input to, for example, a point of sales (POS) register and the like. The electronic receipt system 100 stores, in the storage unit 21, electronic receipt information indicating the received electronic receipt in association with the received user identification information.

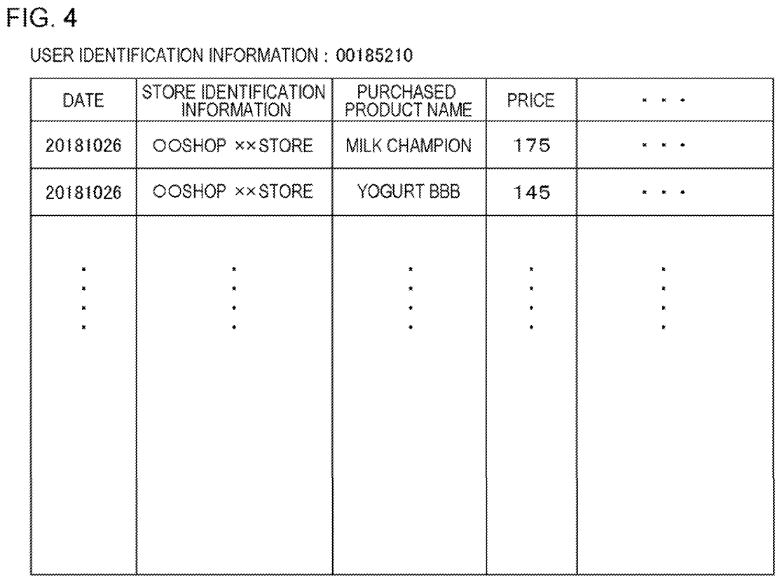

FIG. 4 schematically illustrates one example of electronic receipt information stored in the storage unit 21. In the illustrated example, the electronic receipt information includes information in which a date on which a purchase is made, store identification information that identifies a store where the purchase is made, a purchased product name indicating a purchased product, a price of the purchased product, and the like are associated with each other.

Referring back to FIG. 1, the acquisition unit 14 acquires information stored in the storage unit 21.

The change information acquisition unit 11 acquires change information related to a change in raw material for a product.

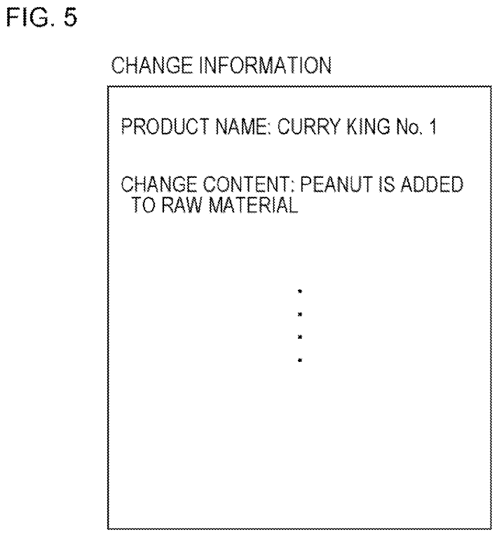

FIG. 5 schematically illustrates one example of change information acquired by the change information acquisition unit 11. The change information illustrated in FIG. 5 includes a product name of a change product being a product having a raw material changed, and a change content. The change content illustrated in FIG. 5 indicates that a new material is added to the raw material.

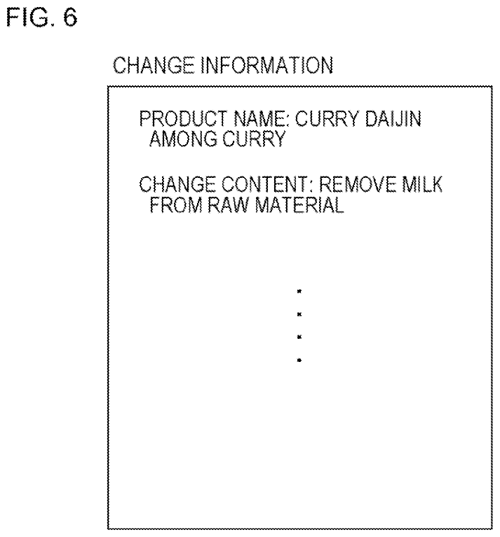

FIG. 6 schematically illustrates another one example of change information acquired by the change information acquisition unit 11. A change content illustrated in FIG. 6 indicates that a predetermined material is removed from a raw material.

The change information may include other information such as a date on which a change is applied, a package picture before the change, and a package picture after the change.

Note that, in the present specification, “acquisition” includes at least any one of “acquisition of data being stored in another apparatus or a storage medium by its own apparatus (active acquisition)”, based on a user input or an instruction of a program, such as reception by making a request or an inquiry to another apparatus and reading by accessing to another apparatus or a storage medium, “inputting of data being output to its own apparatus from another apparatus (passive acquisition)”, based on a user input or an instruction of a program, such as reception of data distributed (transmitted, push-notified, or the like) and acquisition by selection from among received data or received information, and “generation of new data by editing data (such as texting, sorting of data, extraction of a part of data, and change of a file format) and the like, and acquisition of the new data”.

For example, the change information acquisition unit 11 may receive change information transmitted from a system of a manufacturer of each product. In addition, the change information acquisition unit 11 may acquire change information registered by any user. In addition, the change information acquisition unit 11 may acquire change information input by an operator via an input apparatus included in the processing apparatus 10 or an input apparatus connected to the processing apparatus 10.

Referring back to FIG. 1, the target user determination unit 12 determines, based on the electronic receipt information (see FIG. 4) stored in the storage unit 21, a user who has purchased, in the past, a change product being a product having a raw material changed or a related product being related to the change product.

The related product is a product as an alternative to the change product. For example, the related product may be a product of a similar kind (hereinafter, a “similar product”) as that of the change product. In addition, the related product may be a product that is a similar product to the change product and satisfies another alternative condition. For example, the “same manufacturer”, a “price difference from a change product falls within a reference value”, and the like are exemplified as the alternative condition, but the present invention is not limited thereto. The alternative condition may be able to be set by each user.

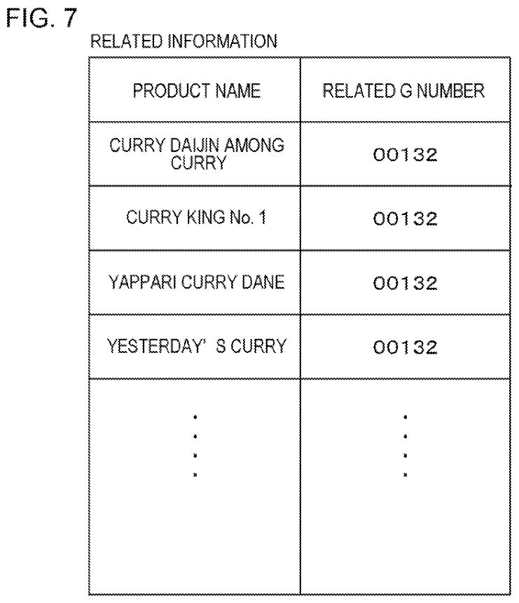

In the present example embodiment, as illustrated in FIG. 7, related information in which products related to each other are associated with each other is stored in the storage unit 21. Then, the target user determination unit 12 determines a related product being related to a change product, based on the related information. Note that, as another example, product information (such as a product kind, a price, and a manufacturer) about each product may be stored in the storage unit 21. Then, the target user determination unit 12 may determine a related product of a change product, based on the product information and the above-described alternative condition.

Referring back to FIG. 1, the notification unit 13 notifies the change information acquired by the change information acquisition unit 11 to a user determined by the target user determination unit 12. Note that, any means can be adopted for a notification unit. For example, the notification unit 13 may display change information in a page displayed on a user terminal after login to the processing apparatus 10 via predetermined website and application. In addition, the notification unit 13 may notify change information by using a push notification function of an application. In addition, an electronic mail address of each user may be registered in advance. Then, the notification unit 13 may notify change information by electronic mail.

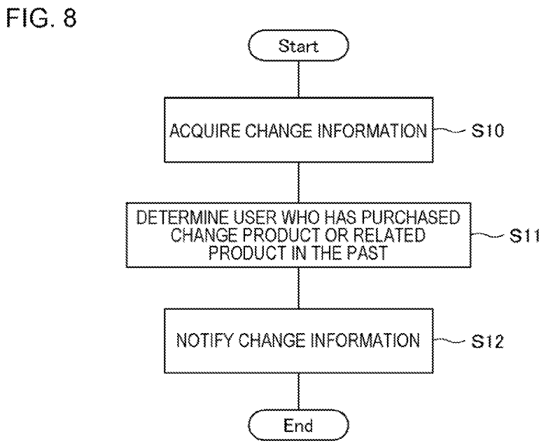

Next, one example of a flow of processing of the processing apparatus 10 will be described by using a flowchart in FIG. 8.

When the change information acquisition unit 11 acquires change information related to a change in raw material for a product (S10), the target user determination unit 12 determines, based on the electronic receipt information (see FIG. 4) stored in the storage unit 21, a user who has purchased, in the past, a change product being a product having a raw material changed or a related product being related to the change product (S11). Then, the notification unit 13 notifies the user determined in S11 of the change information acquired in S10 (S12).

The electronic receipt system 100 according to the present example embodiment described above can notify a change in raw material for a product to a user who has purchased the product in the past and a user who has purchased a product related to the product in the past. In other words, the electronic receipt system 100 can notify an appropriate user of a change in raw material for a product.

Since the notified user can recognize a change in raw material for a product, inconvenience that the user purchases, by mistake, a product including a prohibition material due to a raw material change can be suppressed. Further, inconvenience that, although the notified user can purchase a product that does not include a prohibition material due to a raw material change, the product remains excluded from choices can be suppressed.

Note that, when configuring in such a way that information related to a raw material change is notified to an unspecified large number of all users, not only change information related to a product in which each user is interested but also change information related to a product in which the user is not interested may be notified to the user. As a result, inconvenience that the user fails to notice important information among notified information may occur. The electronic receipt system 100 according to the present example embodiment can suppress such inconvenience.

### Second Example Embodiment

An electronic receipt system 100 according to a present example embodiment is different from that in the first example embodiment in a point that users to be notified of change information are narrowed down based on prohibition information in which a prohibition material is registered for each user. Details will be described below.

One example of a functional block diagram of the electronic receipt system 100 according to the present example embodiment is illustrated in FIG. 1.

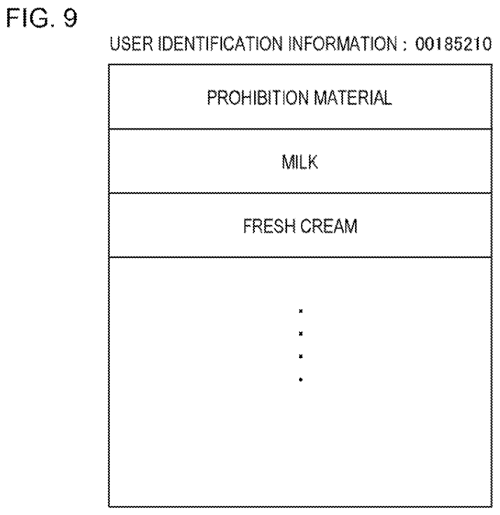

A storage unit 21 stores prohibition information in which a prohibition material is registered for each user. FIG. 9 schematically illustrates one example of the prohibition information. Note that, the electronic receipt system 100 has a configuration in which each user can update a registration content of the prohibition information. Details of the configuration are a design matter.

A target user determination unit 12 determines a user who satisfies following two conditions, based on the electronic receipt information (see FIG. 4) and the prohibition information (see FIG. 9) being stored in the storage unit 21.

A user who has purchased, in the past, a change product being a product having a raw material changed or a related product being related to the change product.

A user who registers, as a prohibition material, a newly added material or a material removed from a raw material being indicated by change information acquired by a change information acquisition unit 11.

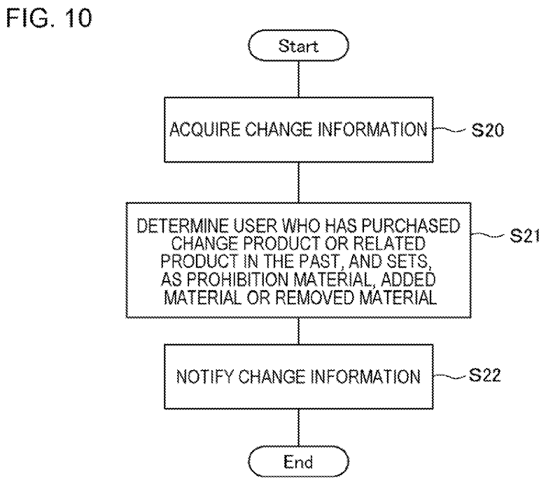

Next, one example of a flow of processing of a processing apparatus 10 will be described by using a flowchart in FIG. 10.

When the change information acquisition unit 11 acquires change information related to a change in raw material for a product (S20), the target user determination unit 12 determines a user who satisfies the following two conditions, based on the electronic receipt information (see FIG. 4) and the prohibition information (see FIG. 9) being stored in the storage unit 21 (S21).

A user who has purchased, in the past, a change product being a product having a raw material changed, or a related product being related to the change product.

A user who registers, as a prohibition material, a newly added material or a material removed from a raw material being indicated by the change information acquired in S20.

Then, a notification unit 13 notifies the user determined in S21 of the change information acquired in S20 (S22).

Another configuration of the electronic receipt system 100 is similar to that in the first example embodiment.

The electronic receipt system 100 according to the present example embodiment described above can achieve an advantageous effect similar to that in the first example embodiment.

Further, the electronic receipt system 100 can notify a change in raw material for a product to a user who has purchased, in the past, the product or a product related to the product, and registers, as a prohibition material, a material added or removed due to the change in raw material. Such an electronic receipt system 100 can narrow down users to be notified of change information to a more appropriate user.

### Third Example Embodiment

An electronic receipt system 100 according to a present example embodiment is different from that in the first example embodiment in a point that users to be notified of change information are narrowed down based on whether a content of change information indicates addition or removal of a raw material. Details will be described below.

One example of a functional block diagram of the electronic receipt system 100 according to the present example embodiment is illustrated in FIG. 1.

When change information acquired by a change information acquisition unit 11 indicates that a new material is added to a raw material, a target user determination unit 12 determines a user who has purchased a change product in the past. Then, when the change information acquired by the change information acquisition unit 11 indicates that a predetermined material is removed from the raw material, the target user determination unit 12 determines a user who has purchased, in the past, a related product being related to the change product.

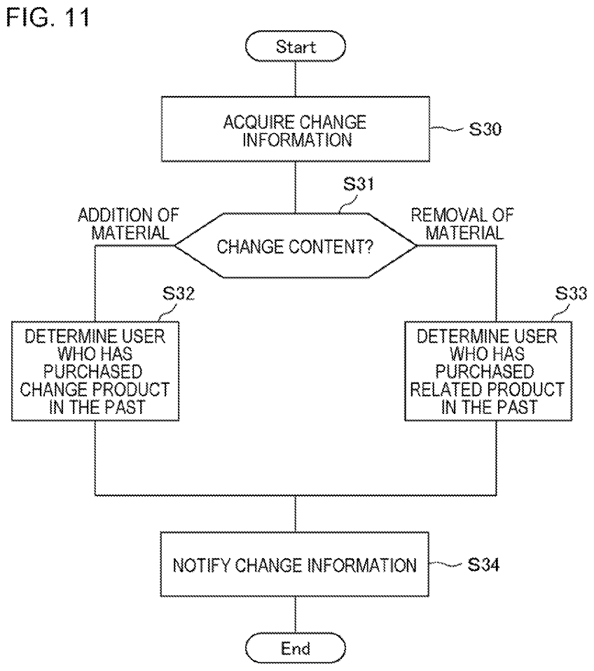

Next, one example of a flow of processing of a processing apparatus 10 will be described by using a flowchart in FIG. 11.

When the change information acquisition unit 11 acquires change information related to a change in raw material for a product (S30), the target user determination unit 12 ascertains a content of the change information (S31).

When the change information acquired in S30 indicates that a new material is added to the raw material (“addition of material” in S31), the target user determination unit 12 determines a user who has purchased a change product in the past (S32). Then, a notification unit 13 notifies the user determined in S32 of the change information indicating that the “new material is added to the raw material” being acquired in S30 (S34).

On the other hand, when the change information acquired in S30 indicates that a predetermined material is removed from the raw material (“removal of material” in S31), the target user determination unit 12 determines a user who has purchased, in the past, a related product being related to the change product (S33). Then, the notification unit 13 notifies the user determined in S33 of the change information indicating that the “predetermined material is removed from the raw material” being acquired in S30 (S34).

Another configuration of the electronic receipt system 100 is similar to that in the first example embodiment.

The electronic receipt system 100 according to the present example embodiment described above can achieve an advantageous effect similar to that in the first example embodiment.

Further, when a content of change information indicates addition of a raw material, the electronic receipt system 100 can notify the change information to a user who has purchased a change product in the past, and, when a content of change information indicates removal of the raw material, the electronic receipt system 100 can notify the change information to a user who has purchased a related product in the past.

When there is addition of a raw material to a certain product, a situation where the product that has been purchased includes a prohibition material and the product cannot be purchased in the future may occur. Thus, it is conceivable that information indicating that there is addition of a raw material to the product is relatively important for a user who purchases the product. On the other hand, it is conceivable that information indicating that there is addition of a raw material to the product is not relatively important for a user who purchases a related product of the product and does not purchase the product because the product is excluded from choices in the first place.

Further, when there is removal of a raw material from a certain product, inconvenience that a prohibition material is included in the product and the like does not particularly occur. Thus, it is conceivable that information indicating that there is removal of a raw material from the product is not relatively important for a user who purchases the product. On the other hand, for a user who purchases a related product of the product and does not purchase the product, a situation where a prohibition material is removed from the raw material due to removal of the raw material and the product can be purchased in the future may occur. As a result, choices increase. Thus, it is conceivable that information indicating that there is removal of a raw material from the product is relatively important for a user who purchases a related product of the product.

In this way, when there is addition of a raw material and when there is removal of a raw material, importance of information thereof is different for each user. The electronic receipt system 100 can determine a user to be notified, based on a content indicated by change information, and can thus narrow down users to be notified of the change information to a more appropriate user.

### Fourth Example Embodiment

An electronic receipt system 100 according to a present example embodiment is different from that in the third example embodiment in a point that users to be notified of change information are narrowed down based on prohibition information in which a prohibition material is registered for each user. Details will be described below.

One example of a functional block diagram of the electronic receipt system 100 according to the present example embodiment is illustrated in FIG. 1.

A storage unit 21 stores prohibition information in which a prohibition material is registered for each user. FIG. 9 schematically illustrates one example of the prohibition information. Note that, the electronic receipt system 100 has a configuration in which each user can update a registration content of the prohibition information. Details of the configuration are a design matter.

When change information acquired by a change information acquisition unit 11 indicates that a new material is added to a raw material, a target user determination unit 12 determines a user who satisfies following two conditions.

A user who has purchased, in the past, a change product being a product having a raw material changed.

A user who registers, as a prohibition material, a newly added material indicated by the change information acquired by the change information acquisition unit 11.

Further, when the change information acquired by the change information acquisition unit 11 indicates that a predetermined material is removed from the raw material, the target user determination unit 12 determines a user who satisfies following two conditions.

A user who has purchased, in the past, a related product being related to the change product.

A user who registers, as a prohibition material, a material removed from the raw material indicated by the change information acquired by the change information acquisition unit 11.

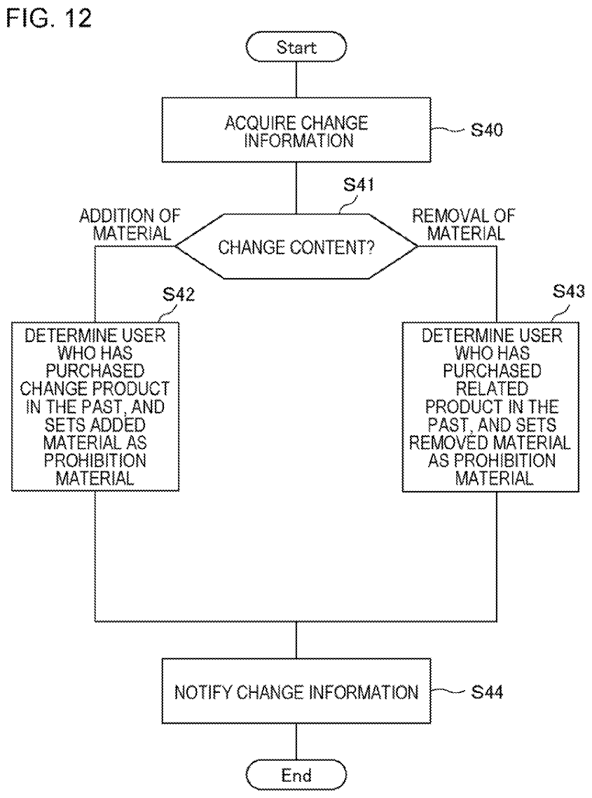

Next, one example of a flow of processing of a processing apparatus 10 will be described by using a flowchart in FIG. 12.

When the change information acquisition unit 11 acquires change information related to a change in raw material for a product (S40), the target user determination unit 12 confirms a content of the change information (S41).

When the change information acquired in S40 indicates that a new material is added to the raw material (“addition of material” in S41), the target user determination unit 12 determines a user who satisfies the following two conditions (S42).

A user who has purchased, in the past, a change product being a product having a raw material changed.

A user who registers, as a prohibition material, a newly added material indicated by the change information acquired by the change information acquisition unit 11.

Then, a notification unit 13 notifies the user determined in S42 of the change information acquired in S40 (S44).

On the other hand, when the change information acquired in S40 indicates that a predetermined material is removed from the raw material (“removal of material” in S41), the target user determination unit 12 determines a user who satisfies the following two conditions (S43).

A user who has purchased, in the past, a related product being related to the change product.

A user who registers, as a prohibition material, a material removed from the raw material indicated by the change information acquired by the change information acquisition unit 11.

Then, the notification unit 13 notifies the user determined in S43 of the change information acquired in S40 (S44).

Another configuration of the electronic receipt system 100 is similar to that in the first to third example embodiments.

The electronic receipt system 100 according to the present example embodiment described above can achieve an advantageous effect similar to that in the first to third example embodiments.

### Fifth Example Embodiment

An electronic receipt system 100 according to a present example embodiment is different from that in the first to fourth example embodiments in a point that the electronic receipt system 100 according to the present example embodiment has a function of searching for a purchased product including a material specified by a user from a purchased product being purchased in the past by the user. Details will be described below.

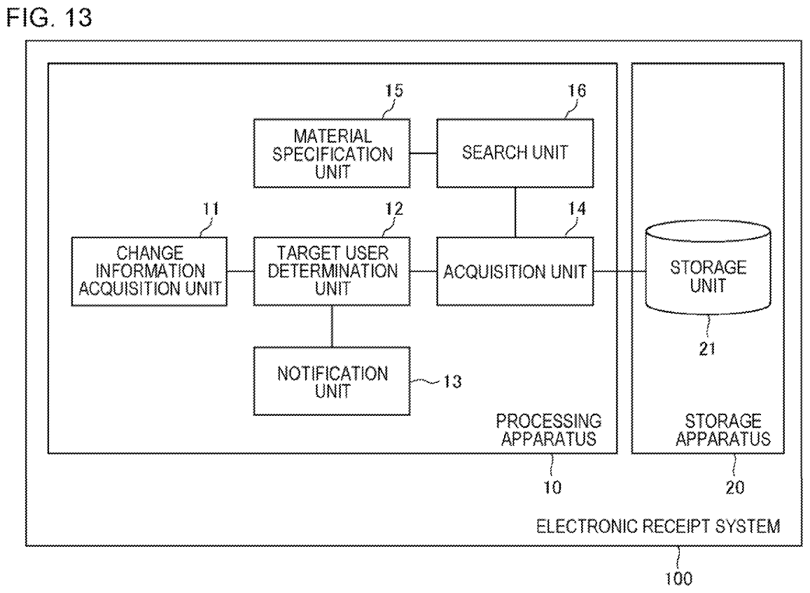

FIG. 13 is one example of a functional block diagram of the electronic receipt system 100 according to the present example embodiment. The electronic receipt system 100 according to the present example embodiment is different from that in the first to fourth example embodiments in a point that a processing apparatus 10 includes a material specification unit 15 and a search unit 16.

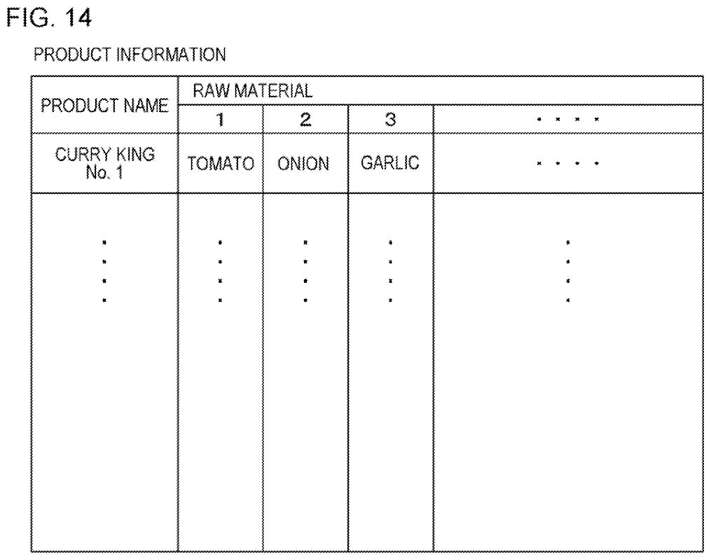

A storage unit 21 stores product information indicating a raw material for each of a plurality of products. FIG. 14 schematically illustrates one example of the product information stored in the storage unit 21.

The material specification unit 15 specifies a material, based on a user input. For example, a user operates a user terminal and logs in to the processing apparatus 10 via predetermined website and application by using user identification information of himself/herself, and the user then displays a search screen for searching for a predetermined purchased product on a display. Then, the user specifies a material on the search screen.

The search unit 16 searches for a purchased product including a material specified by the material specification unit 15 from a purchased product indicated by electronic receipt information to be processed, based on the electronic receipt information (see FIG. 4) and the product information (see FIG. 14) being stored in the storage unit 21. The electronic receipt information to be processed is electronic receipt information associated with user identification information of a user who specifies a material.

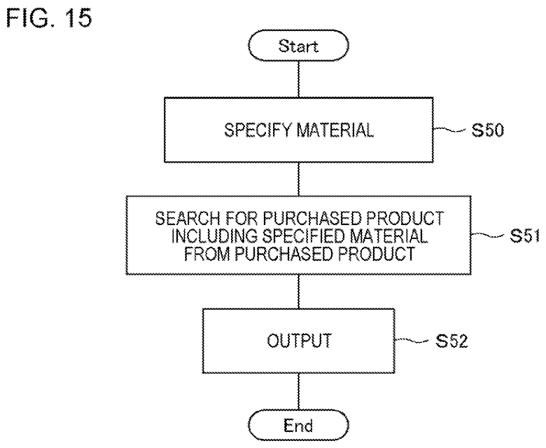

Next, one example of a flow of processing of the processing apparatus 10 will be described by using a flowchart in FIG. 15.

For example, a user operates a user terminal and logs in to the processing apparatus 10 via predetermined website and application by using user identification information of himself/herself, and the user then displays a search screen for searching for a predetermined purchased product on a display. Then, the user specifies a material on the search screen.

In response to this, the material specification unit 15 specifies a material specified by the user (S50). Next, the search unit 16 searches for a purchased product including the material specified in S50 from a purchased product indicated by electronic receipt information to be processed (S51). The electronic receipt information to be processed is electronic receipt information associated with user identification information of a user who specifies a material.

Then, the processing apparatus 10 transmits a search result to the user terminal (S52). For example, when there is a purchased product including the material specified in S50, the processing apparatus 10 transmits information indicating the purchased product. On the other hand, when there is no purchased product including the material specified in S50, the processing apparatus 10 transmits information indicating that there is no purchased product including the material specified in S50.

Another configuration of the electronic receipt system 100 is similar to that in the first to fourth example embodiments.

The electronic receipt system 100 according to the present example embodiment described above can achieve an advantageous effect similar to that in the first to fourth example embodiments.

Herein, PTLs 1 to 3 are all techniques for determining whether a product including a prohibition material is included in a product to be settled at a time of purchase (at a time of settlement). Whether a product including a prohibition material is included in a purchased product cannot be determined after purchase. For example, it may be desired to confirm whether a product including a prohibition material is included in a product being purchased in the past, when a person having a food allergy visits, when a new allergic symptom is developed from an allergic substance that has been no problem, and the like.

The electronic receipt system 100 according to the present example embodiment can search for a product including a predetermined material from a purchased product. In other words, the electronic receipt system 100 can provide a function that fits the need as described above, and solve the problem described above.

### Sixth Example Embodiment

An electronic receipt system 100 according to a present example embodiment is different from that in the fifth example embodiment in a point that the electronic receipt system 100 according to the present example embodiment has a function of searching for, from a purchased product being purchased in the past by a user, a purchased product including a material specified by the user and having a predetermined time limit satisfying a predetermined condition. Details will be described below.

One example of a functional block diagram of the electronic receipt system 100 according to the present example embodiment is illustrated in FIG. 13.

An electronic receipt according to the present example embodiment includes information indicating a predetermined time limit (first time limit). The first time limit may be an expiration date and a best before date determined for each product. In addition, the first time limit may be a day after a lapse of a predetermined number of days since a purchase date. The predetermined number of days may be a value common to all products, and may be a value different for each product.

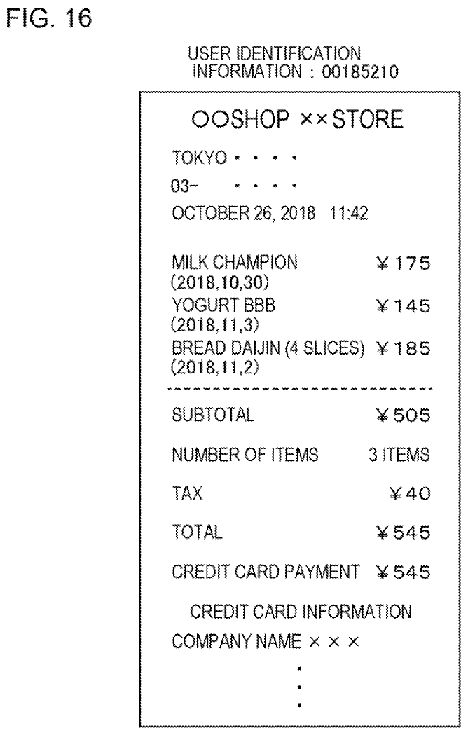

FIG. 16 schematically illustrates one example of the electronic receipt according to the present example embodiment. The illustrated electronic receipt includes an expiration date or a best before date (parentheses under a product name) of each product, and a purchase date. For example, a code (for example: a bar code and a two-dimensional code) provided to each product may include an expiration date or a best before date in addition to product identification information. Then, by reading the code with a POS register at a time of settlement at a store, an expiration date or a best before date of each product may be input to the POS register.

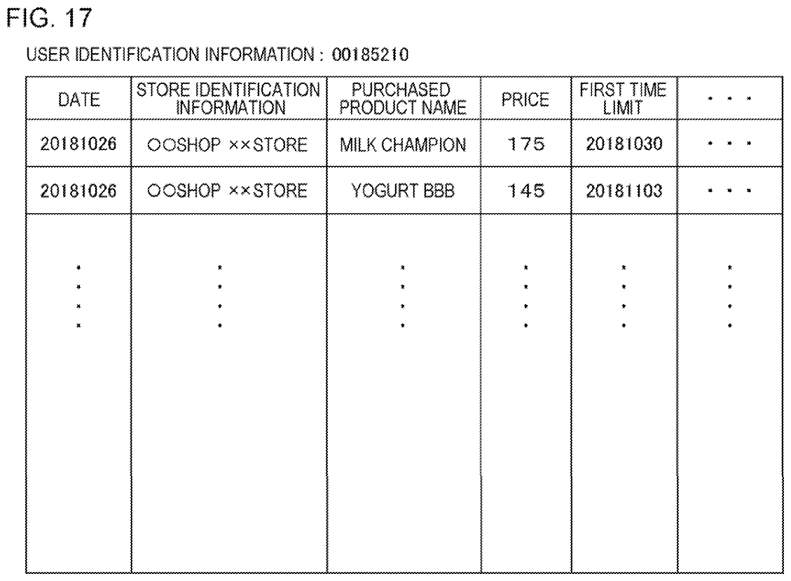

FIG. 17 illustrates one example of electronic receipt information stored in a storage apparatus 20 according to the present example embodiment. The illustrated electronic receipt information further includes a first time limit of each product.

Referring back to FIG. 13, a search unit 16 searches for, based on the electronic receipt information (see FIG. 17) and the product information (see FIG. 14) being stored in a storage unit 21, a purchased product including a material specified by a material specification unit 15 and having a first time limit satisfying a predetermined condition from a purchased product indicated by electronic receipt information to be processed. The predetermined condition is that the “first time limit is not exceeded”.

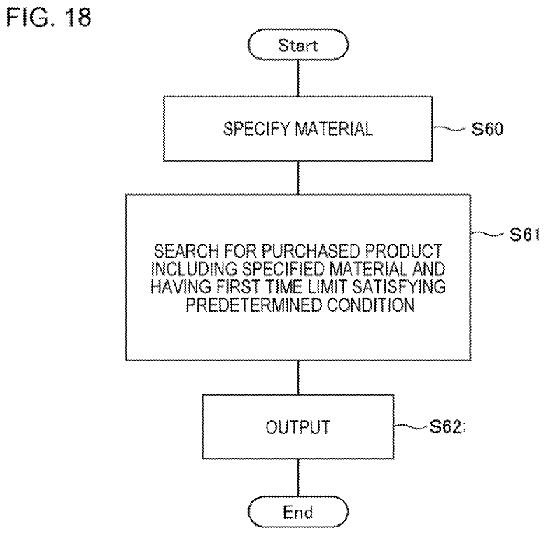

Next, one example of a flow of processing of a processing apparatus 10 will be described by using a flowchart in FIG. 18.

For example, a user operates a user terminal and logs in to the processing apparatus 10 via predetermined website and application by using user identification information of himself/herself, and the user then displays a search screen for searching for a predetermined purchased product on a display. Then, the user specifies a material on the search screen.

In response to this, the material specification unit 15 specifies a material specified by the user (S60). Next, the search unit 16 searches for, from a purchased product indicated by electronic receipt information to be processed, a purchased product including the material specified in S60 and having a first time limit satisfying a predetermined condition (S61). The electronic receipt information to be processed is electronic receipt information associated with user identification information of a user who specifies a material.

Then, the processing apparatus 10 transmits a search result to the user terminal (S62).

Another configuration of the electronic receipt system 100 is similar to that in the fifth example embodiment.

The electronic receipt system 100 according to the present example embodiment described above can achieve an advantageous effect similar to that in the fifth example embodiment.

Further, the electronic receipt system 100 according to the present example embodiment can search for, from a purchased product, a product including a predetermined material and having a first time limit satisfying a predetermined condition. The first time limit is, for example, “an expiration data, a best before date, a day after a lapse of a predetermined number of days since a purchase date, and the like”, and the predetermined condition is, for example, the “first time limit is not exceeded”. In this case, a purchased product including a predetermined material and being likely to remain without being consumed can be searched for from the purchased product.

Such an electronic receipt system 100 can search for a purchased product including a predetermined material and being likely to remain without being consumed from the purchased product being purchased in the past, when a person having a food allergy visits, when a new allergic symptom is developed from an allergic substance that has been no problem, and the like, for example. As a result, a user can easily recognize a purchased product to be paid attention to in the purchased product that is likely to remain at present.

### Seventh Example Embodiment

An electronic receipt system 100 according to a present example embodiment is different from that in the fifth and sixth example embodiments in a point that the electronic receipt system 100 according to the present example embodiment has a function of searching for a purchased product including a material specified by a user from the purchased product being purchased in the past by a plurality of users. The electronic receipt system 100 according to the present example embodiment is used at, for example, a party where a plurality of persons bring their own purchased products, and the like. Details will be described below.

One example of a functional block diagram of the electronic receipt system 100 according to the present example embodiment is illustrated in FIG. 13.

A search unit 16 searches for a purchased product including a material specified by a material specification unit 15 from a purchased product indicated by electronic receipt information to be processed, based on electronic receipt information (see FIG. 4) and product information (see FIG. 14) being stored in a storage unit 21.

The electronic receipt information to be processed is electronic receipt information associated with user identification information of each of a plurality of users, and is electronic receipt information specified by each of the plurality of users.

For example, each user operates a user terminal and logs in to a processing apparatus 10 via predetermined website and application by using user identification information of himself/herself, and the user then specifies predetermined electronic receipt information from a piece of electronic receipt information of himself/herself. In a case of the example of a “party where a plurality of persons bring their own purchased products” described above, a user specifies, from a piece of electronic receipt information of himself/herself, electronic receipt information indicating a purchase of a product to be brought to the party.

Electronic receipt information specified by each of a plurality of users is gathered on the electronic receipt system 100. For example, a user may perform an input of transmitting specified electronic receipt information to a predetermined first user (for example: an organizer of a party). In this case, a storage unit 21 stores the electronic receipt information specified by a plurality of users in association with user identification information of the first user. Note that, the storage unit 21 stores electronic receipt information indicating a purchase history of the first user and electronic receipt information transmitted from another user in such a way that the pieces of electronic receipt information can be discriminated. Note that, a means for gathering electronic receipt information specified by each of a plurality of user is not limited to this, and any function can be adopted.

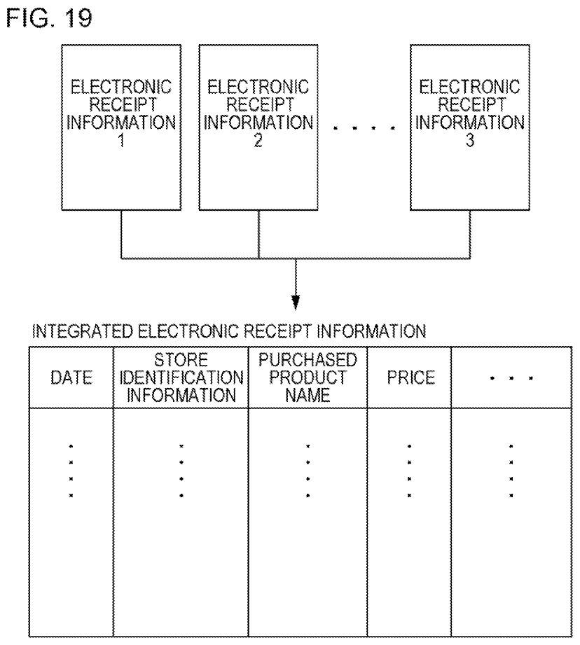

As illustrated in FIG. 19, a search unit 16 generates integrated electronic receipt information acquired by integrating pieces of electronic receipt information specified by each of a plurality of users. Next, the search unit 16 searches for a purchased product including a material specified by a material specification unit 15 from a purchased product indicated by the integrated electronic receipt information.

Another configuration of the electronic receipt system 100 is similar to that in the fifth and sixth example embodiments.

The electronic receipt system 100 according to the present example embodiment described above can achieve an advantageous effect similar to that in the fifth and sixth example embodiments.

Further, the electronic receipt system 100 according to the present example embodiment can generate integrated electronic receipt information by integrating pieces of electronic receipt information indicating a purchase history of each of a plurality of users, and search for a purchased product including a material specified by a user from a purchased product indicated by the integrated electronic receipt information. The electronic receipt system 100 can perform search processing on all purchased products together being purchased by a plurality of users, and thus a work efficiency of a user improves as compared to the example in which each of a plurality of users individually performs the search processing described in the fifth example embodiment and the sixth example embodiment.

### Eighth Example Embodiment

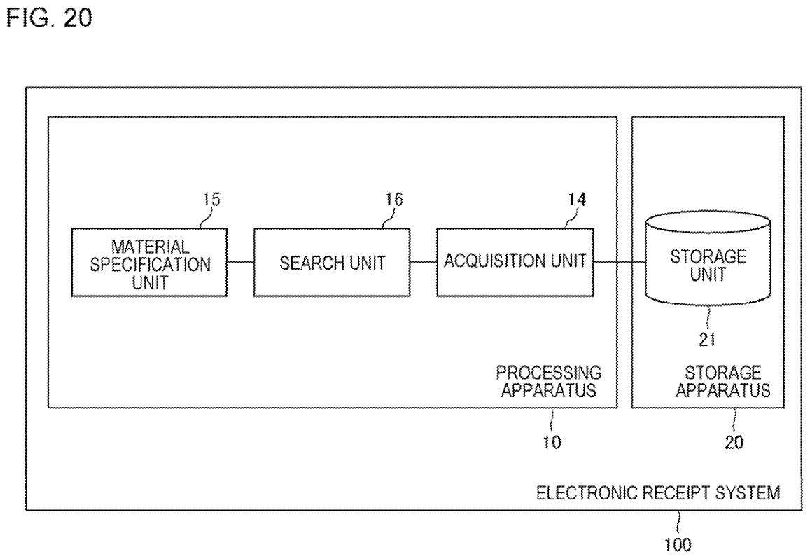

FIG. 20 is one example of a functional block diagram of an electronic receipt system 100 according to a present example embodiment. As illustrated, the electronic receipt system 100 according to the present example embodiment is different from that in the fifth to seventh example embodiments in a point that a processing apparatus 10 does not include a change information acquisition unit 11, a target user determination unit 12, and a notification unit 13. Another configuration is similar to that in the fifth to seventh example embodiments. The electronic receipt system 100 according to the present example embodiment can achieve an advantageous effect similar to that in the fifth to seventh example embodiments.

### Ninth Example Embodiment

An electronic receipt system 100 according to a present example embodiment is different from that in the first to eighth example embodiments in a point that the electronic receipt system 100 according to the present example embodiment has a function of notifying a predetermined person when a purchase of a product including a prohibition material is detected. Details will be described below.

One example of a functional block diagram of the electronic receipt system 100 according to the present example embodiment is illustrated in FIG. 1 or 13.

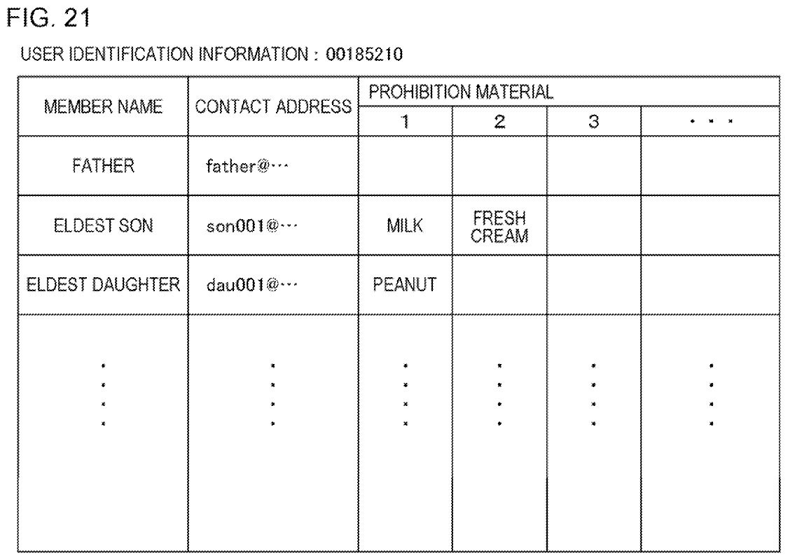

A storage unit 21 stores contact address information indicating a person to be notified and a contact address when a purchase of a product including a prohibition material is detected. FIG. 21 schematically illustrates one example of the contact address information. A plurality of notified persons can be registered in association with one user. For example, a user is a person who does shopping for a family, and a notified person is a member of the family.

When a notification unit 13 acquires new electronic receipt information from a store system, the notification unit 13 determines whether a product including a prohibition material registered by a user is included in a purchased product indicated by the electronic receipt information. When the product is included, the notification unit 13 determines a notified target, based on the contact address information (FIG. 21).

Note that, for example, as illustrated in FIG. 21, a prohibition material related to each of persons to be notified may be registered in association with each of the persons. Then, when the notification unit 13 detects a purchase of a product including a first prohibition material, the notification unit 13 may determine a person associated with the first prohibition material as a person to be notified.

Another configuration of the electronic receipt system 100 is similar to that in the first to eighth example embodiments.

The electronic receipt system 100 according to the present example embodiment described above can achieve an advantageous effect similar to that in the first to eighth example embodiments.

Further, a purchased product may be consumed by not only a person who makes a purchase but also a person different from the person who makes the purchase. Thus, when a product including a prohibition material is purchased, the purchase needs to be notified to not only a person who made the purchase but also a person (for example: a family) who is likely to consume the purchased product and the like. The electronic receipt system 100 according to the present example embodiment can notify an appropriate person of a purchase of a product including a prohibition material.

Hereinafter, examples of reference manners are presented as supplementary notes.

1. An electronic receipt system, including:

a storage unit storing electronic receipt information for each user;

a change information acquisition unit acquiring change information related to a change in raw material for a product;

a target user determination unit determining, based on the electronic receipt information, a user who has purchased, in the past, a change product being a product having a raw material changed or a related product being related to the change product; and a notification unit notifying a determined user of the change information.

2. The electronic receipt system according to supplementary note 1, wherein,

when the change information indicates that a new material is added to a raw material, the target user determination unit determines a user who has purchased the change product in the past.

3. The electronic receipt system according to supplementary note 2, wherein

the storage unit stores prohibition information in which a prohibition material is registered for each user, and,

when the change information indicates that a new material is added to a raw material, the target user determination unit determines a user who has purchased the change product in the past and registers the new material as the prohibition material.

4. The electronic receipt system according to any of supplementary notes 1 to 3, wherein,

when the change information indicates that a predetermined material is removed from a raw material, the target user determination unit determines a user who has purchased, in the past, the related product being related to the change product.

5. The electronic receipt system according to supplementary note 4, wherein

the storage unit stores prohibition information in which a prohibition material is registered for each user, and,

when the change information indicates that a predetermined material is removed from a raw material, the target user determination unit determines a user who has purchased, in the past, the related product being related to the change product and registers the predetermined material as the prohibition material.

6. The electronic receipt system according to any of supplementary notes 1 to 5, further including:

a material specification unit specifying a material; and

a search unit searching for, from a purchased product indicated by electronic receipt information to be processed, the purchased product including a specified material.

7. The electronic receipt system according to supplementary note 6, wherein

the search unit searches for, from the purchased product indicated by electronic receipt information to be processed, the purchased product including a specified material and having a first time limit of the purchased product indicated by the electronic receipt information satisfying a predetermined condition.

8. A processing method executed by a computer, including:

storing electronic receipt information for each user;

a change information acquisition step of acquiring change information related to a change in raw material for a product;

a target user determination step of determining, based on the electronic receipt information, a user who has purchased, in the past, a change product being a product having a raw material changed or a related product being related to the change product; and

a notification step of notifying a determined user of the change information.

9. A processing apparatus, including:

an acquisition unit acquiring electronic receipt information;

a change information acquisition unit acquiring change information related to a change in raw material for a product;

a target user determination unit determining, based on the electronic receipt information, a user who has purchased a change product being a product having a raw material changed or a related product being related to the change product; and

a notification unit notifying the determined user of the change information.

10. A processing apparatus, including:

a material specification unit specifying a material; and

a search unit searching for, from a purchased product indicated by electronic receipt information to be processed, the purchased product including a specified material and having a first time limit of the purchased product indicated by the electronic receipt information satisfying a predetermined condition.

This application is based upon and claims the benefit of priority from Japanese patent application No. 2018-236670, filed on Dec. 18, 2018, the disclosure of which is incorporated herein in its entirety by reference.

What is claimed is:

1. An electronic receipt system, comprising:
at least one memory configured to store one or more instructions; and
at least one processor configured to execute the one or more instructions to:
store electronic receipt information for each user;
acquire change information related to a change in raw material for a product;
determine, based on the electronic receipt information, a user who has purchased, in the past, a change product being a product having a raw material changed or a related product being related to the change product; and
notify a determined user of the change information.

2. The electronic receipt system according to claim 1,
wherein the processor is further configured to execute the one or more instructions to determine, when the change information indicates that a new material is added to a raw material, a user who has purchased the change product in the past.

3. The electronic receipt system according to claim 2,
wherein the processor is further configured to execute the one or more instructions to:
store prohibition information in which a prohibition material is registered for each user, and,
when the change information indicates that a new material is added to a raw material, determine a user who has purchased the change product in the past and register the new material as the prohibition material.

4. The electronic receipt system according to claim 1,
wherein the processor is further configured to execute the one or more instructions to determine, when the change information indicates that a predetermined material is removed from a raw material, a user who has purchased, in the past, the related product being related to the change product.

5. The electronic receipt system according to claim 4,
wherein the processor is further configured to execute the one or more instructions to:
store prohibition information in which a prohibition material is registered for each user, and,
when the change information indicates that a predetermined material is removed from a raw material, determine a user who has purchased, in the past, the related product being related to the change product and register the predetermined material as the prohibition material.

6. The electronic receipt system according to claim 1,
wherein the processor is further configured to execute the one or more instructions to:
specify a material; and
search for, from a purchased product indicated by electronic receipt information to be processed, the purchased product including a specified material.

7. The electronic receipt system according to claim 6,
wherein the processor is further configured to execute the one or more instructions to search for, from the purchased product indicated by electronic receipt information to be processed, the purchased product including a specified material and having a first time limit of the purchased product indicated by the electronic receipt information satisfying a predetermined condition.

8. A processing method executed by a computer, comprising:
storing electronic receipt information for each user;
acquiring change information related to a change in raw material for a product;
determining, based on the electronic receipt information, a user who has purchased, in the past, a change product being a product having a raw material changed or a related product being related to the change product; and
notifying a determined user of the change information.

9. A processing apparatus, comprising:
at least one memory configured to store one or more instructions; and
at least one processor configured to execute the one or more instructions to:
acquire electronic receipt information;
acquire change information related to a change in raw material for a product;
determine, based on the electronic receipt information, a user who has purchased a change product being a product having a raw material changed or a related product being related to the change product; and
notify a determined user of the change information.

10. (canceled)
